(19) United States
(12) Patent Application Publication
(10) Pub. No.: US 2026/0204838 A1
(43) Pub. Date: Jul. 16, 2026

(54) CABLE HARNESS

(71) Applicant: BIZLINK INTERNATIONAL CORP., New Taipei City (TW)

(72) Inventors: Yanping ZHANG, New Taipei City (TW); Qixing XU, New Taipei City (TW); Haoran ZOU, New Taipei City (TW)

(21) Appl. No.: 19/019,393

(22) Filed: Jan. 13, 2025

(51) Int. Cl. H01R 13/58

(52) U.S. Cl. CPC H01R 13/5812

(57) ABSTRACT

A cable harness includes a first housing, a terminal module, a second housing, an interconnecting piece and a cable module. The terminal module is disposed in the first housing and has some terminals. The second housing has a hook-like structure. The interconnecting piece is disposed at the first housing for connecting with the second housing and has a connecting portion connected with the terminal module; a platform-like structure having an abutting surface and a cantilever; and a cylinder-like structure having two pivots. The cable module enters from the second housing and connects with the terminals by penetrating through the interconnecting piece. The second housing abuts the abutting surface and the cantilever does not contact the hook-like structure in a first status. The cantilever abuts the hook-like structure in a second status for controlling a rotational angle of the second housing relative to the first housing.

### BACKGROUND

### Technical Field

The present disclosure relates to cable harnesses. More particularly, the present disclosure relates to harnesses for transmission of high current.

### Description of Related Art

In the Chinese patent 102763289B, a cable harness is disclosed. A cable is allowed to be inserted into the housing of this cable harness through a cable guiding hole, which is inclined to the housing at an angle. Since this angle is structurally fixed, the inclination of the cable relative to the housing is also fixed. In other words, this cable harness does not allow the inclination of the cable to be changed relative to the housing. Thus, the flexibility of application of this cable harness is limited.

### SUMMARY

A cable harness includes a first housing, a terminal module, a second housing, an interconnecting piece and a cable module. The terminal module is disposed in the first housing and has some terminals. The second housing has a hook-like structure. The interconnecting piece is disposed at the first housing for connecting with the second housing. The interconnecting piece has a connecting portion connected with the terminal module; a platform-like structure having an abutting surface and a cantilever, the hook-like structure can abut against the cantilever; and a cylinder-like structure having two pivots formed on both lateral sides thereof. The cable module enters from the second housing and connects with the terminals by wholly penetrating through the interconnecting piece. The cable harness can switch between a first status and a second status to allow an angle adjustment of the cables while maintaining a high structural strength, thereby enhancing the flexibility of application.

### BRIEF DESCRIPTION OF THE DRAWINGS

The disclosure can be more fully understood by reading the following detailed description of the embodiments, with reference made to the accompanying drawings as follows:

FIG. 1 is a schematic view of an cable harness according to an embodiment of the present disclosure;

FIG. 2 is an exploded view of the cable harness of FIG. 1;

FIG. 3 is a schematic view of the cable harness of FIG. 1, in which the angle adjuster is omitted for drawing clarity;

FIG. 4 is a schematic view of the first subsidiary housing and the hook-like structure of FIG. 1;

FIG. 5 is a schematic view of the second subsidiary housing of FIG. 1;

FIG. 6 is a sectional view along the sectional line A-A of FIG. 1;

FIG. 7 is a side view of the cable harness of FIG. 1 in the first status; and

FIG. 8 is a side view of the cable harness of FIG. 1 in the second status.

### DETAILED DESCRIPTION

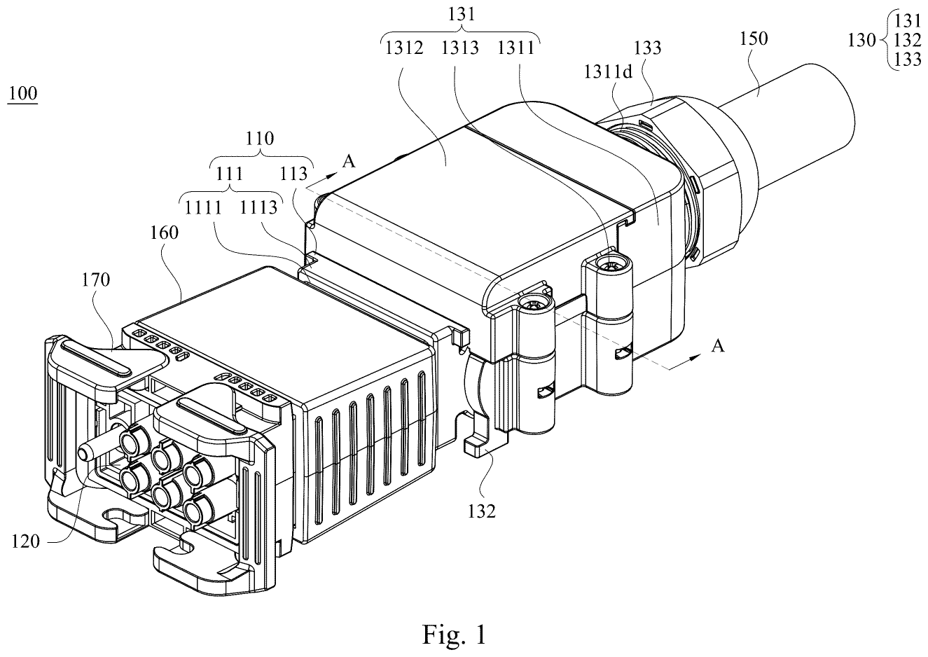

FIGS. 1-8 are drawn according to the actual scale. For the sake of concise description in this specification, the scales of the elements are not listed one by one. However, the scale and position of each element should be regarded as part of the scope of this specification.

Furthermore, if the description in this specification is insufficient to explain the detailed design of the elements and makes it uneasy to implement, please take the electrical connector disclosed in the Chinese patent 102763289B or the Chinese patent 213124974U as a reference.

As shown in FIGS. 1-8, a cable harness 100 is provided in the present disclosure. Moreover, for example, the cable harness 100 is utilized for electrical connection of high current.

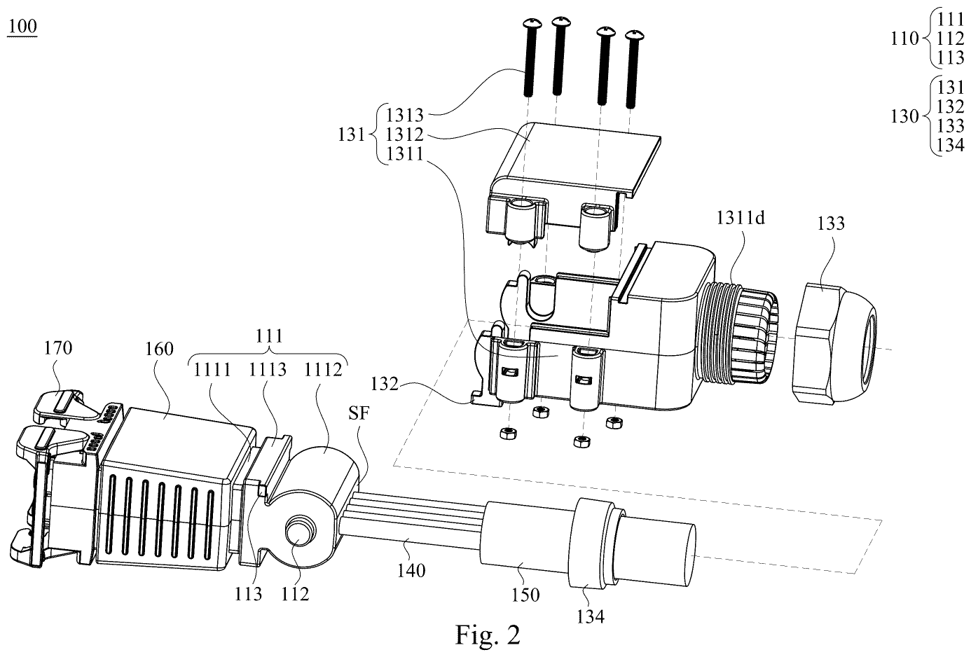

Reference is made to FIGS. 1-2. FIG. 1 is a schematic view of a cable harness 100 according to an embodiment of the present disclosure. FIG. 2 is an exploded view of the cable harness 100 of FIG. 1. In this embodiment, as shown in FIGS. 1-2, a cable harness 100 includes an interconnecting piece 110, a terminal module 120, a first housing 160, a plurality of latches 170, an angle adjuster 130, a plurality of cables 140 and a cable sleeve 150. The angle adjuster 130 is rotatably connected with the interconnecting piece 110.

Moreover, as shown in FIG. 2, the angle adjuster 130 includes a second housing 131, at least one hook-like structure 132, a nut 133 and a water proof ring 134. The hook-like structure 132 is connected with the second housing 131. The cable sleeve 150 covers around a portion of each of the cables 140. The cable sleeve 150 is spaced apart from the interconnecting piece 110. This means the cable sleeve 150 does not contact with the interconnecting piece 110. The cable sleeve 150 penetrates through the nut 133. The cables 140 are connected with the terminal module 120, and the cables 140 penetrate through the interconnecting piece 110 and the second housing 131. Moreover, the second housing 131 includes a first subsidiary housing 1311, a second subsidiary housing 1312 and at least one fastener 1313. The second subsidiary housing 1312 is detachably connected with the first subsidiary housing 1311. To be specific, the cables 140 penetrate through the first subsidiary housing 1311.

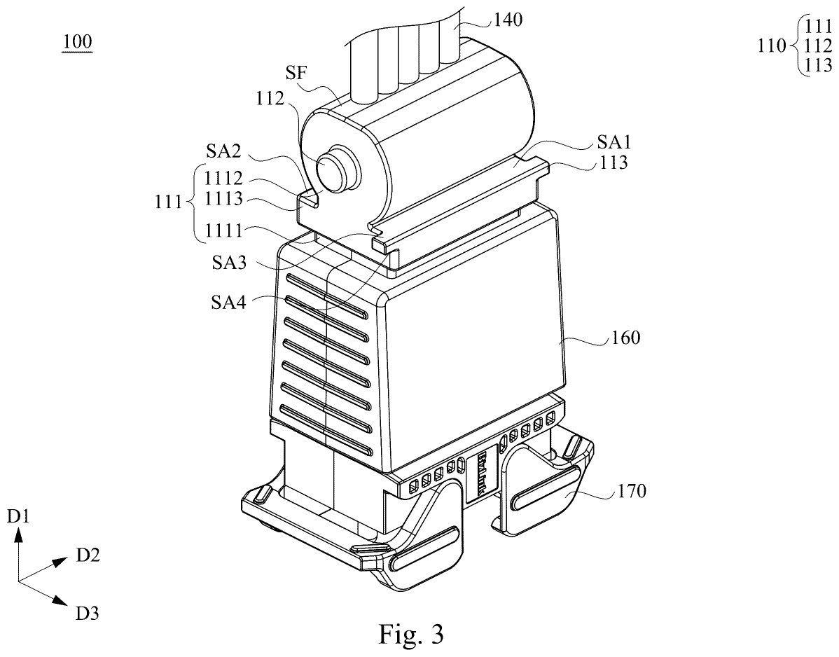

Reference is further made to FIG. 3. FIG. 3 is a schematic view of the cable harness 100 of FIG. 1, in which the angle adjuster 130 is omitted for drawing clarity. In this embodiment, as shown in FIGS. 1-3, the interconnecting piece 110 includes a main body 111, a shaft-like structure 112 and at least one cantilever 113. The cables 140 penetrate through the main body 111. The shaft-like structure 112 is connected with the main body 111. The terminal module 120 is connected with the main body 111. The cantilever 113 is connected with the main body 111. The second housing 131 of the angle adjuster 130 is rotatably connected with the shaft-like structure 112. The hook-like structure 132 of the angle adjuster 130 is configured to abut against the cantilever 113 of the interconnecting piece 110.

Furthermore, as shown in FIGS. 1-3, the main body 111 includes a connecting portion 1111, a cylinder-like structure 1112 and a platform-like structure 1113. The connecting portion 1111 is connected with the terminal module 120. The connecting portion 1111 is at least partially disposed within the first housing 160. The latches 170 are rotatably connected with the first housing 160 respectively. The cylinder-like structure 1112 is connected with a side of the connecting portion 1111 away from the terminal module 120 along a first direction D1. The cylinder-like structure 1112 has a flat surface SF away from the connecting portion 1111. The cables 140 penetrate into the main body 111 through the flat surface SF. The cable sleeve 150 is spaced apart from the cylinder-like structure 1112. The shaft-like structure 112 is disposed on the cylinder-like structure 1112 along a second direction D2. The platform-like structure 1113 is connected between the connecting portion 1111 and the cylinder-like structure 1112 along the first direction D1. The platform-like structure 1113 is exposed out of the first housing 160. The platform-like structure 1113 has a first abutting surface SA1 and a second abutting surface SA2. The cylinder-like structure 1112 is located between the first abutting surface SA1 and the second abutting surface SA2 along a third direction D3. The cantilever 113 is connected with the platform-like structure 1113 along the second direction D2. The cantilever 113 is adjacent to the first abutting surface SA1. The first direction D1, the second direction D2 and the third direction D3 are perpendicular to each other.

Moreover, as shown in FIG. 3, the cantilever 113 has a third abutting surface SA3 and a fourth abutting surface SA4. The fourth abutting surface SA4 is opposite to the third abutting surface SA3. In this embodiment, the first abutting surface SA1, the second abutting surface SA2 and the third abutting surface SA3 are coplanar with each other.

In practical applications, as shown in FIGS. 2-3, a quantity of the cantilever 113 is two. The platform-like structure 1113 is connected between the cantilevers 113 along the second direction D2. In other words, the cantilevers 113 are arranged at opposite sides of the platform-like structure 1113. The cantilevers 113 are aligned with each other.

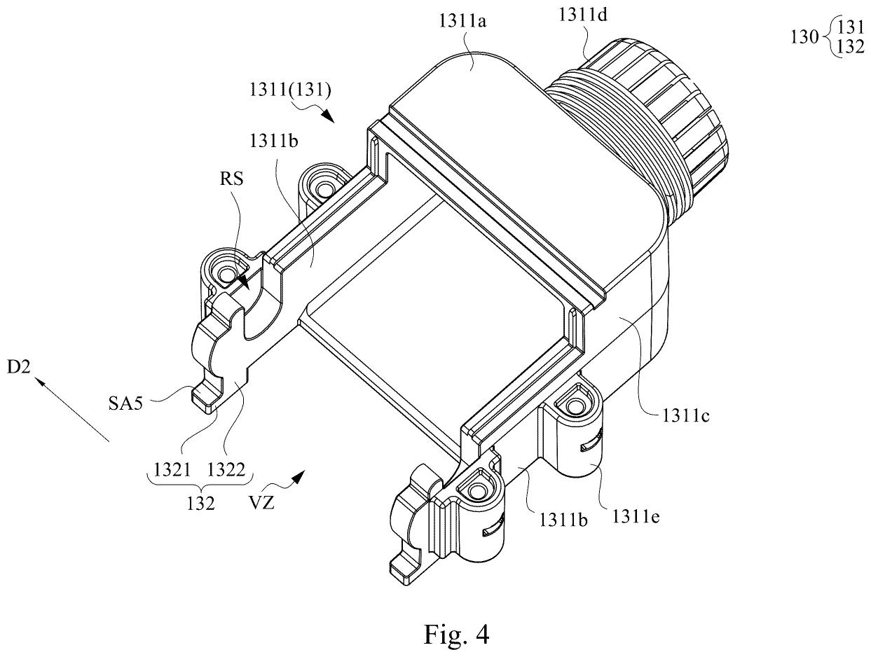

Reference is made to FIG. 4. FIG. 4 is a schematic view of the first subsidiary housing 1311 and the hook-like structure 132 of FIG. 1. In this embodiment, as shown in FIG. 4, the first subsidiary housing 1311 includes a base 1311a, two extending walls 1311b, a surrounding wall 1311c, a cable fixing tube 1311d and at least one first locking portion 1311e. The extending walls 1311b are spaced apart from each other. Each of the extending walls 1311b has a recessed space RS. In practice, a quantity of the hook-like structure 132 is plural. For example, as shown in FIG. 4, a quantity of the hook-like structure 132 is two, and the hook-like structures 132 are aligned with each other along the second direction D2. Moreover, each of the hook-like structures 132 is disposed on one of the extending walls 1311b and thus the hook-like structures 132 are spaced apart from each other. Similarly, in practice, a quantity of the first locking portion 1311e is plural, and each of the first locking portions 1311e is disposed on one of the extending walls 1311b. The surrounding wall 1311c is connected between the base 1311a and the extending walls 1311b. The extending walls 1311b extend away from the base 1311a. The extending walls 1311b are at least partially free from contact with each other to define a voided zone VZ therebetween. The cable fixing tube 1311d is connected with the base 1311a. As shown in FIGS. 1-2, the cable sleeve 150 with the cables 140 covered therein penetrate through the base 1311a and the cable fixing tube 1311d of the first subsidiary housing 1311. The nut 133 is configured to couple with the cable fixing tube 1311d to fix the cable sleeve 150 to the cable fixing tube 1311d. Moreover, the water proof ring 134 is disposed between the cable fixing tube 1311d and the cable sleeve 150.

Furthermore, as shown in FIG. 4, each of the hook-like structures 132 includes an abutting part 1321 and a connecting part 1322. The abutting part 1321 has a fifth abutting surface SA5. The connecting part 1322 is connected between the abutting part 1321 and one of the extending walls 1311b. Practically speaking, the abutting part 1321 and the connecting part 1322 substantially form an L shape as a hook.

In practical applications, the first subsidiary housing 1311 and the hook-like structures 132 are one piece formed. This means the base 1311a, the extending walls 1311b, the surrounding wall 1311c, the cable fixing tube 1311d and the hook-like structures 132 are formed from a single piece of material.

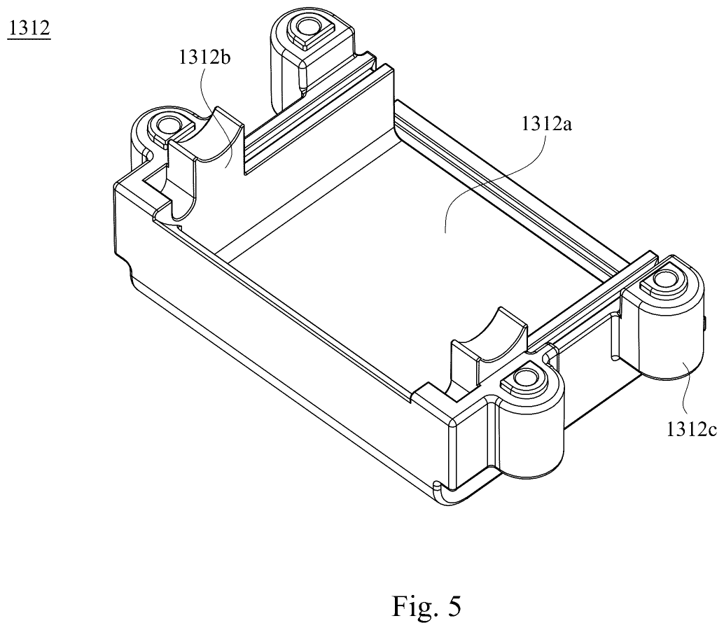

Reference is made to FIG. 5. FIG. 5 is a schematic view of the second subsidiary housing 1312 of FIG. 1. In this embodiment, as shown in FIG. 5, the second subsidiary housing 1312 includes a cover 1312a, two positioning parts 1312b and at least one second locking portion 1312c. The positioning parts 1312b are connected with the cover 1312a. The second locking portion 1312c is disposed on the cover 1312a. The fastener 1313 is configured to connect with the first locking portion 1311e and the second locking portion 1312c, as shown in FIGS. 1-2. In practical applications, a quantity of the fastener 1313 is plural, and each of the fasteners 1313 is a combination of a screw and a nut.

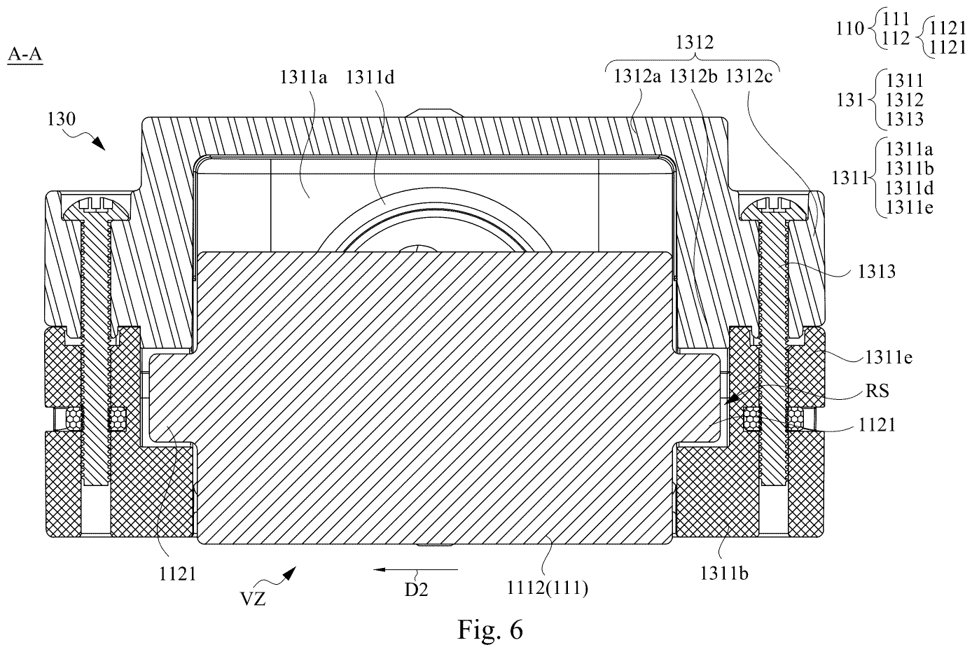

Reference is made to FIG. 6. FIG. 6 is a sectional view along the sectional line A-A of FIG. 1. In this embodiment, as shown in FIG. 6, the shaft-like structure 112 includes two pivots 1121. The pivots 1121 are axially aligned with each other. The cylinder-like structure 1112 is connected between the pivots 1121 along the second direction D2. Furthermore, the cover 1312a of the second subsidiary housing 1312 is detachably connected with the extending walls 1311b and the surrounding wall 1311c of the first subsidiary housing 1311. The cylinder-like structure 1112 of the main body 111 is at least partially located in the voided zone VZ. The recessed space RS on each of the extending walls 1311b is configured to accommodate one of the pivots 1121 of the shaft-like structure 112. The positioning parts 1312b of the second subsidiary housing 1312 are respectively accommodated in a corresponding one of the recessed spaces RS, such that the pivots 1121 are restricted in the recessed spaces RS. In other words, the pivots 1121 are respectively sandwiched between the first subsidiary housing 1311 and the second subsidiary housing 1312 in a secure way.

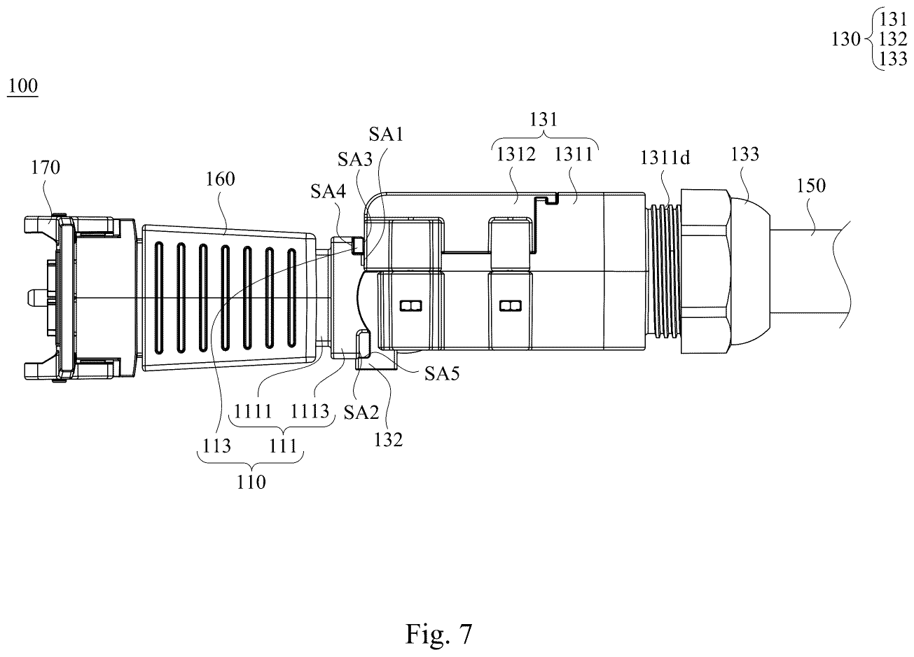

Reference is made to FIG. 7. FIG. 7 is a side view of the cable harness 100 of FIG. 1 in the first status. It is worth to note that, the angle adjuster 130 is configured to rotate relative to the main body 111 of the interconnecting piece 110 to switch between a first status and a second status. In the first status, as shown in FIG. 7, a front end surface of the second subsidiary housing 1312 of the second housing 131 at least partially abuts against the first abutting surface SA1 of the platform-like structure 1113 and the third abutting surface SA3 of each of the cantilevers 113, while the hook-like structure 132 of the angle adjuster 130 is spaced apart from the cantilever 113 of the interconnecting piece 110. Practically, in the first status, the angle adjuster 130 and thus the cable sleeve 150 align along a straight line with the interconnecting piece 110 and the terminal module 120.

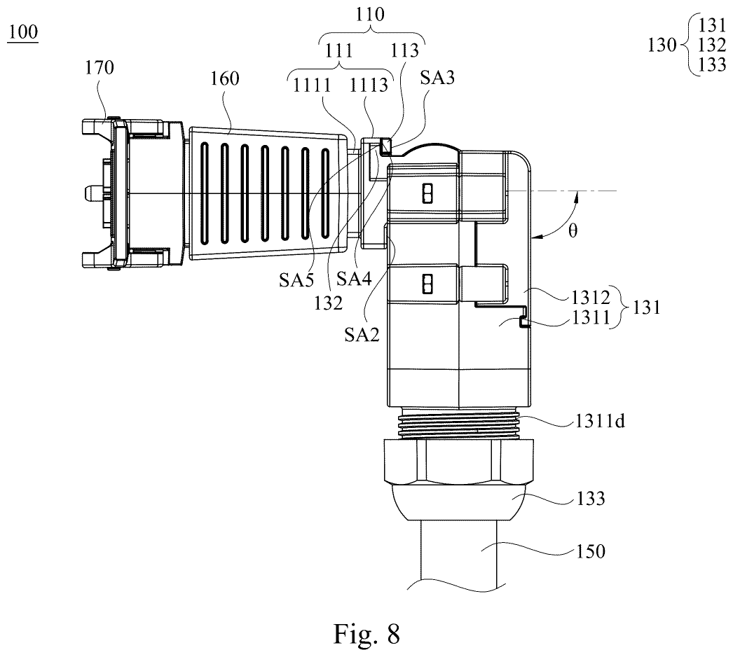

Reference is made to FIG. 8. FIG. 8 is a side view of the cable harness 100 of FIG. 1 in the second status. In practice, a rotational angle θ of the angle adjuster 130 relative to the main body 111 between the first status and the second status is 90 degrees. In the second status, as shown in FIG. 8, the first subsidiary housing 1311 of the second housing 131 at least partially abuts against the second abutting surface SA2 of the platform-like structure 1113, while the fifth abutting surface SA5 of each of the hook-like structures 132 abuts against the fourth abutting surface SA4 of a corresponding one of the cantilevers 113. Practically, in the second status, the angle adjuster 130 and thus the cable sleeve 150 form a right angle with the interconnecting piece 110 and the terminal module 120.

Since the angle adjuster 130 is configured to rotate relative to the main body 111 of the interconnecting piece 110 to switch between a first status and a second status, the angle of the cable sleeve 150 (with the cables 140 therein) relative to the interconnecting piece 110 and the terminal module 120 can be adjusted, thereby enhancing the flexibility of application of the cable harness 100.

Moreover, after the angle adjuster 130 is rotated relative to the interconnecting piece 110 from the first status to the second status, in addition to the first subsidiary housing 1311 of the second housing 131 at least partially abutting against the second abutting surface SA2 of the platform-like structure 1113, the fifth abutting surface SA5 of each of the hook-like structures 132 also abuts against the fourth abutting surface SA4 of a corresponding one of the cantilevers 113. Therefore, the structural strength of the cable harness 100 after rotation can be effectively enhanced.

In conclusion, the aforementioned embodiments of the present disclosure have at least the following advantages:
(1) Since the angle adjuster is configured to rotate relative to the main body of the interconnecting piece to switch between a first status and a second status, the angle of the cable sleeve (with the cables therein) relative to the interconnecting piece and the terminal module can be adjusted, thereby enhancing the flexibility of application of the cable harness.
(2) After the angle adjuster is rotated relative to the interconnecting piece from the first status to the second status, in addition to the first subsidiary housing of the second housing at least partially abutting against the second abutting surface of the platform-like structure, the fifth abutting surface of each of the hook-like structures also abuts against the fourth abutting surface of a corresponding one of the cantilevers. Therefore, the structural strength of the cable harness after rotation can be effectively enhanced.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A cable harness for power transmission, comprising:
a first housing having a front end and a rear end opposite to the front end,
a terminal module disposed in the first housing, the terminal module having a plurality of terminals;
a second housing having at least one hook-like structure formed on a surface thereof;
an interconnecting piece disposed at the rear end of the first housing for connecting with the second housing to allow the second housing to be rotatably connected with the first housing, the interconnecting piece being one-piece formed and having, along a first direction from the front end to the rear end, a connecting portion connected with the terminal module; a platform-like structure having a first abutting surface facing opposite to the first housing, the platform-like structure having at least one cantilever adjacent to the first abutting surface, the hook-like structure being configured to abut against the cantilever; and a cylinder-like structure having two pivots formed on both lateral sides thereof; and
a cable module entering from the second housing and electrically connecting with the terminals of the terminal module by penetrating through a whole of the interconnecting piece,
wherein, when the cable harness is in a first status, a front end surface of the second housing abuts the first abutting surface and the cantilever is free from direct contact with the hook-like structure, and
wherein, when the cable harness is in a second status, the cantilever abuts against the hook-like structure for controlling a maximum rotational angle of the second housing relative to the first housing.

2. The cable harness of claim 1, wherein the pivots are axially aligned with each other along a second direction, the platform-like structure has a second abutting surface, the cylinder-like structure is located between the first abutting surface and the second abutting surface along a third direction, the first direction, the second direction and the third direction are perpendicular to each other, the second housing at least partially abuts against the first abutting surface in the first status and at least partially abuts against the second abutting surface in the second status.

3. The cable harness of claim 2, wherein a quantity of the cantilever is two, the cantilevers are aligned with each other and arranged at opposite sides of the platform-like structure along the second direction, a quantity of the hook-like structure is two, the hook-like structures are spaced apart from and aligned with each other along the second direction.

4. The cable harness of claim 2, wherein the second housing comprises:
a first subsidiary housing, the cable module penetrates through the first subsidiary housing, the first subsidiary housing at least partially abuts against the second abutting surface in the second status; and
a second subsidiary housing detachably connected with the first subsidiary housing, the pivots are respectively sandwiched between the first subsidiary housing and the second subsidiary housing, the second subsidiary housing at least partially abuts against the first abutting surface in the first status.

5. The cable harness of claim 4, wherein the first subsidiary housing comprises:
a base, the cable module penetrates through the base;
two extending walls spaced apart from each other, each of the extending walls has a recessed space configured to accommodate one of the pivots, the hook-like structure is disposed on one of the extending walls; and
a surrounding wall connected between the base and the extending walls, the extending walls extend away from the base,
the second subsidiary housing comprises:
a cover detachably connected with the extending walls and the surrounding wall; and
two positioning parts connected with the cover and respectively accommodated in a corresponding one of the recessed spaces, such that the pivots are restricted in the recessed spaces.

6. The cable harness of claim 5, wherein the extending walls are at least partially free from contact with each other to define a voided zone therebetween, the cylinder-like structure is at least partially located in the voided zone.

7. The cable harness of claim 5, further comprising:
a nut,
wherein the cable module comprises:
a plurality of cables; and
a cable sleeve covering around a portion of each of the cables, the cable sleeve penetrates through the nut and is spaced apart from the cylinder-like structure,
wherein the first subsidiary housing further comprises:
a cable fixing tube connected with the base, the cable sleeve penetrates through the cable fixing tube, the nut is configured to couple with the cable fixing tube to fix the cable sleeve to the cable fixing tube.

8. The cable harness of claim 7, wherein the first subsidiary housing and the hook-like structure are one piece formed.

9. The cable harness of claim 7, further comprising:
a water proof ring disposed between the cable fixing tube and the cable sleeve.

10. The cable harness of claim 7, wherein the cylinder-like structure has a flat surface away from the connecting portion, the cables penetrate into the connecting portion through the flat surface.

11. The cable harness of claim 5, wherein the first subsidiary housing further comprises at least one first locking portion disposed on one of the extending walls, the second subsidiary housing further comprises at least one second locking portion disposed on the cover, the second housing further comprises:
at least one fastener configured to connect with the first locking portion and the second locking portion.

12. The cable harness of claim 5, wherein the cantilever has a third abutting surface and a fourth abutting surface opposite to the third abutting surface, the first abutting surface, the second abutting surface and the third abutting surface are coplanar with each other, the second subsidiary housing at least partially abuts against the third abutting surface in the first status, the hook-like structure comprises:
an abutting part having a fifth abutting surface configured to abut against the fourth abutting surface in the second status; and
a connecting part connected between the abutting part and one of the extending walls.

13. The cable harness of claim 12, wherein the abutting part and the connecting part substantially form an L shape.

14. The cable harness of claim 2, wherein the connecting portion is at least partially disposed within the first housing, the platform-like structure is exposed out of the first housing.

15. The cable harness of claim 1, further comprising:
a plurality of latches rotatably connected with the first housing respectively.

16. The cable harness of claim 1, wherein a rotational angle of the second housing relative to the connecting portion between the first status and the second status is 90 degrees.

17. A cable harness, comprising:
an interconnecting piece, comprising:
a main body;
a shaft-like structure connected with the main body; and
a pair of protrusions connected with the main body;
a terminal module connected with the main body;
an angle adjuster, comprising:
a casing rotatably connected with the shaft-like structure; and
a pair of L-shaped structures connected with the casing and respectively configured to abut against a corresponding one of the protrusions; and
a plurality of cables connected with the terminal module and penetrating through the main body and the casing,
wherein the angle adjuster is configured to rotate relative to the main body to switch between a first status and a second status, the casing abuts a portion of the main body and the protrusions are spaced apart from the L-shaped structures in the first status, the casing abuts another portion of the main body and the protrusions abut against the L-shaped structures in the second status.
